(19) United States
(12) Patent Application Publication
(10) Pub. No.: US 2022/0102916 A1
(43) Pub. Date: Mar. 31, 2022

(54) COMPACT, HIGH SPEED ELECTRICAL CONNECTOR

(71) Applicant: Amphenol Commercial Products (Chengdu) Co., Ltd., Chengdu (CN)

(72) Inventors: Yunxiang Liu, Chengdu (CN); Lei Liao, Shenzhen (CN); Luyun Yi, Chengdu (CN)

(73) Assignee: Amphenol Commercial Products (Chengdu) Co., Ltd., Chengdu (CN)

(21) Appl. No.: 17/477,352

(22) Filed: Sep. 16, 2021

(30) Foreign Application Priority Data
Sep. 25, 2020 (CN) 202022135407.9

(51) Int. Cl. H01R 13/6471; H01R 13/502; H01R 43/20

(52) U.S. Cl. CPC H01R 13/6471; H01R 43/20; H01R 13/502

(57) ABSTRACT

An electrical connector including a front housing member, signal and ground terminals disposed in a row in the front housing member, a cover member mounted to a rear of the front housing member, and a lossy member disposed in the cover member and contacting the ground terminals. Such a configuration improves signal integrity of the electronical connector while simplifying the manufacture and assembly of the electrical connector and reducing the cost thereof.

### RELATED APPLICATIONS

This application claims priority to and the benefit of Chinese Patent Application Serial No. 202022135407.9, filed on Sep. 25, 2020. The entire contents of these applications are incorporated herein by reference in their entirety.

### FIELD

This application relates to electrical connectors, and in particular to an electrical connector for providing an electrical connection between electronic systems.

### BACKGROUND

Electrical connectors are used to provide electrical connections between different electronic systems through conductive terminals. In certain applications, an electrical connector may provide an electrical connection between a first electronic system, such as a motherboard, and a second electronic system, such as a daughter card. Tail portions of the conductive terminals of the electrical connector are electrically connected to conductive portions of the first electronic system by, for example, soldering.

The electrical connector may act as a female connector for interfacing directly with conductive portions on or near the edge of the second electronic system, such as a daughter card, such that the conductive portions of the second electronic system are in contact with contact portions of the corresponding conductive terminals of the electrical connector. In this way, the conductive portions of the second electronic system may be electrically connected to the corresponding conductive portions of the first electronic system via the conductive terminals of the electrical connector, thereby establishing the electrical connection between the first electronic system and the second electronic system.

In other system configurations, a connector mounted to an electronic system may form interface indirectly with the second electronic system through a cable. The cable may be terminated with a plug connector that mates with a plug connector attached to a cable that is in turn connected to the electronic system. Electrical connections to the first electronic are nonetheless established through the conductive terminals of the connector mounted to the first electronic system.

### BRIEF SUMMARY

Aspects of the present disclosure relate to compact, high speed electrical connectors with improved signal integrity.

Some embodiments relate to an electrical connector. The electrical connector may include a front housing member comprising a front member and a cover member mounted to a rear of the front member; a plurality of terminals arranged in the front housing member; and a bridging member comprising portions extending through the cover member and engaging a subset of the plurality of terminals.

In some embodiments, the bridging member may provide a conductive or partially conductive path among ground terminals of the plurality of terminals.

In some embodiments, the bridging member may be made of an electrically lossy material.

In some embodiments, the plurality of terminals may be arranged in two terminal rows mutually opposed and spaced apart, with the terminals in each of the terminal row aligned therein.

In some embodiments, the two terminal rows may be spaced apart in a manner that the terminals are offset from each other or aligned with each other along an arrangement direction.

In some embodiments, at least a portion of the plurality of terminals each may include a contact portion, a tail portion, and a body portion extending between the contact portion and the tail portion. For each of the at least a portion of the plurality of terminals, an accommodation space may form adjacent the body portion.

In some embodiments, a dimension of the accommodation space may match with a cross-sectional dimension of the cover member such that the cover member can be received in the accommodation space.

In some embodiments, the cover member may be fused to the front housing member and retain the at least a portion of the plurality of terminals in the front housing member.

In some embodiments, the cover member may include a recess. The bridging member may be disposed in the recess such that an outer surface of the cover member is approximately flush with an outer surface of the front member.

In some embodiments, the plurality of terminals may include signal terminals and ground terminals. The ground terminals may form the subset of the plurality of terminals. The ground terminals may include protruding portions extending from the body portions of the ground terminals into respective accommodation spaces.

Some embodiments relate to an electrical connector. The electrical connector may include a front housing member; a plurality of terminals disposed in a row in the front housing member, the plurality of terminals each comprising a contact portion, a tail portion, a body portion extending between the contact portion and the tail portion, and an accommodation space in parallel to the body portion, the plurality of terminals comprising ground terminals comprising protrusion portions protruding into respective accommodation spaces; and a lossy member comprising slots receiving the protrusion portions of the ground terminals.

In some embodiments, the front housing member may include top and bottom faces opposite each other, left and right side faces opposite each other, and front and rear side faces opposite each other, the front side face comprising a socket, the rear side face comprising a cavity. The electrical connector may include a cover member disposed in the cavity of the rear side face of the front housing member and fused to the front housing member.

In some embodiments, the cover member may include slots. The slots of the lossy member may be accessible via the slots of the cover member.

In some embodiments, the protruding portions of the ground terminals may protrude into the slots of the cover member.

In some embodiments, the lossy member may include a plurality of pairs of ribs. The slots of the lossy member may be between pairs of the plurality of pairs of ribs.

In some embodiments, the protruding portions of the ground terminals may be sandwiched between respective pairs of the plurality of pairs of ribs whereby the ground terminals are connected to the lossy member.

In some embodiments, the cover member may include a recess for receiving the lossy member.

Some embodiments relate to a method of manufacturing an electrical connector comprising a plurality of terminals each comprising a contact portion, a tail portion, and a body portion extending between the contact portion and the tail portion. The method may include inserting the plurality of terminals into a front housing member through an opening in a rear of the front housing; inserting a cover member into the opening in the rear and securing the cover member to the front housing; and filling a cavity of the cover member with lossy material.

In some embodiments, the cover member may be secured to the front housing member by a hot melt process.

In some embodiments, the filling the cavity of the cover member with the lossy material may include before or after the cover member is attached, molding the lossy material into the cavity, or inserting a member molded from the lossy material into the cavity.

Some embodiments relate to an electrical connector. The electrical connector may include a front housing member; a plurality of terminals may be arranged in the front housing member, the plurality of terminals comprising signal terminals and ground terminals; a cover member mounted to the front housing member; and a bridging member disposed in the cover member and connecting the ground terminals together.

In some embodiments, the bridging member may provide a conductive or partially conductive path among the ground terminals which may reduce electrical resonances.

In some embodiments, the bridging member may be made of an electrically lossy material.

In some embodiments, the bridging member may be molded to the cover member.

In some embodiments, the bridging member may be made as a separate member and may be mounted to the cover member.

In some embodiments, the cover member may electrically isolate the signal terminals from the bridging member.

In some embodiments, the plurality of terminals may be arranged in one or more terminal rows in the front housing member, with the terminals in each of the terminal rows aligned therein.

In some embodiments, the plurality of terminals may be arranged in two terminal rows mutually opposed and spaced apart, with the terminals in each of the terminal row aligned therein.

In some embodiments, the two terminal rows may be spaced apart in a manner that the terminals may be offset from each other or aligned with each other along an arrangement direction.

In some embodiments, at least one of the one or more terminal rows may include ground terminals and a plurality of pairs of signal terminals, and the ground terminals may separate the plurality of pairs of signal terminals from each other.

In some embodiments, each terminal in each of the at least one terminal row may include a contact portion, a tail portion and a body portion extending between the contact portion and the tail portion, and the body portion may form an accommodation space.

In some embodiments, the cover member may include at least one cover member, a dimension of the accommodation space of one terminal row of the at least one terminal row may match with a cross-sectional dimension of a corresponding cover member of the at least one cover member, such that the corresponding cover member can be received in the accommodation space of the one terminal row.

In some embodiments, the corresponding cover member may retain the one terminal row in the front housing member when received in the accommodation space of the one terminal row.

In some embodiments, the front housing member may include a first cavity, and the corresponding cover member may retain the one terminal row in the first cavity.

In some embodiments, an outer surface of the corresponding cover member may be approximately flush with that of the front housing member.

In some embodiments, each of the ground terminals may further include a protruding portion extending from the body portion of the ground terminal into the accommodation space.

In some embodiments, each of the at least one cover member may include a first set of slots, and at least a portion of the bridging member may be accessible via the first set of slots.

In some embodiments, the protruding portion of each of the ground terminals may be inserted into the bridging member through a corresponding one of the first set of slots in the cover member, when the corresponding cover member may be received in the accommodation space.

In some embodiments, the bridging member may further include a plurality of pairs of ribs extending therefrom, each pair of the plurality of pair of ribs may define a slot therebetween, and each pair of the plurality of pairs of ribs may be inserted in a corresponding one of the first set of slots in the cover member and may be accessible via the corresponding slot.

In some embodiments, the protruding portion of each of the ground terminals may be sandwiched between a corresponding pair of the plurality of pairs of ribs, whereby each of the ground terminals may be connected to the bridging member.

In some embodiments, the cover member may further include a first recess recessed into the cover member for receiving the bridging member.

In some embodiments, the corresponding cover member may be secured to the front housing member by a hot melt process.

In some embodiments, the corresponding cover member may include a second set of slots, and the front housing member may include a first set of protrusions extending into the first cavity and may be capable of mating with the second set of slots.

In some embodiments, the corresponding cover member may further include a thermal melt bar capable of being heated and melted to flow into the second set of slots so as to secure the corresponding cover member to the front housing member, when the first set of protrusions mate with the second set of slots.

These techniques may be used alone or in any suitable combination. The foregoing summary is provided by way of illustration and is not intended to be limiting.

### BRIEF DESCRIPTION OF DRAWINGS

The above and other aspects of the present disclosure will be more thoroughly understood and appreciated below when read in conjunction with the appended drawings. It should be noted that the appended drawings are only schematic and are not drawn to scale. In the appended drawings:

FIG. 1A is a perspective view of a right triangle connector, according to some embodiments.

FIG. 1B is another perspective view of the right angle connector shown in FIG. 1A.

FIG. 1C is a front view of the right angle connector shown in FIG. 1A.

FIG. 1D is a rear view of the right angle connector shown in FIG. 1A with the cover member and the bridging member removed.

FIG. 1E is a cross-sectional view along line E-E in FIG. 1C.

FIG. 1F is a cross-sectional view along line F-F in FIG. 1C.

FIG. 1G is a bottom view of the right angle connector shown in FIG. 1A.

FIG. 1H is an exploded view of the right angle connector shown in FIG. 1A.

FIG. 2 is a perspective view of the front housing member of the right angle connector shown in FIG. 1A, according to some embodiments.

FIG. 3A is a perspective view of some of the terminals in a first terminal row of the right angle connector shown in FIG. 1A.

FIG. 3B is another perspective view of the terminals shown in FIG. 3A with the ground terminals connected to the bridging member.

FIG. 4A is a perspective view of the set of three terminals of FIG. 3A.

FIG. 4B is a perspective view of a ground terminal of the set of three terminals shown in FIG. 4A.

FIG. 4C is a side view of the ground terminal shown in FIG. 4B.

FIG. 4D is a perspective view of a signal terminal of the set of three terminals shown in FIG. 4A.

FIG. 4E is a side view of the signal terminal shown in FIG. 4D.

FIG. 5A is a perspective view of the cover member of the right angle connector shown in FIG. 1A.

FIG. 5B is another perspective view of the cover member shown in FIG. 5A.

FIG. 6A is a perspective view of the bridging member of the right angle connector shown in FIG. 1A.

FIG. 6B is another perspective view of the bridging member shown in FIG. 6A.

### LIST OF REFERENCE NUMERALS

1 electrical connector
100 front housing member
101 top face
103 bottom face
105 front side face
107 rear side face
109 left side face
111 right side face
113a first socket
113b second socket
115a first positioning protrusion
115b second positioning protrusion
116 mounting slot
117a first cavity
118a first opening
119a terminal slot
121a a first set of protrusions
200 terminals
200a a first terminal row
200b a second terminal row
201 contact portion
203 tail portion
205 body portion
207 accommodation space
209 protruding portion
210 ground terminal
220 first signal terminal
230 second signal terminal
300 bridging member
301 first surface
303 second surface
305a, 305b ribs
307 slot
cover member
401 first surface
403 second surface
405 first recess
407 a first set of slots
409 a second set of slots
411 hot melting bar.

### DETAILED DESCRIPTION

Described herein is a compact, high speed electrical connector. The inventors have recognized techniques to simplify the assembly of the electrical connector and reduce the cost thereof. These techniques may be used alone or in combination. In some embodiments, the electrical connector may include a front housing member, signal and ground terminals disposed in a row in the front housing member, a cover member mounted to a rear of the front housing member, and a lossy member disposed in the cover member and contacting the ground terminals.

In some embodiments, the lossy member may be disposed in a recess of the cover member.

In some embodiments, portions of the lossy member may extend through the cover member to engage ground terminals. The ground terminals may be connected through the lossy member, for example, by inserting protruding portions of the ground terminals between the ribs of the lossy member through slots in the cover member.

In some embodiment, the cover member may be disposed in the accommodation spaces formed adjacent to body portions that are between contact portions and tails of the terminals, which may enable mounting the cover member in the front housing member without substantially changing external dimensions of the front housing member and thus without increasing the space occupied by the electrical connector on an electronic system. In some embodiments, the terminals may be retained in place by the cover member, which may eliminate the need to overmold the front housing member around the terminals or the need to provide an additional terminal retention mechanism. Further, intermediate portions of signal terminals may be securely retained within the front housing member without barbs or other features that change the width or other physical characteristics such that a relatively long intermediate portion is of uniform dimensions. In some embodiments, the cover may be fused to the front housing portion, such as by hot melting, for example. Securing the cover member to the front housing member may improve the stability of attachment of the bridging member to the electrical connector.

Preferred embodiments of the present disclosure are described in detail below in conjunction with some examples. It should be appreciated by the skilled person in the art that these embodiments are not meant to form any limitation on the present disclosure.

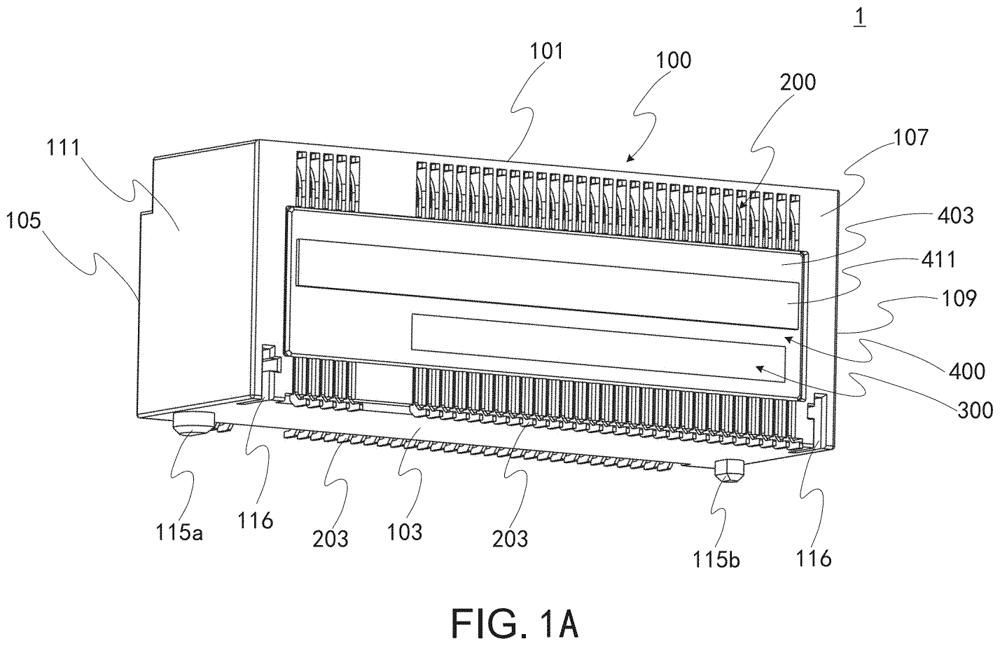

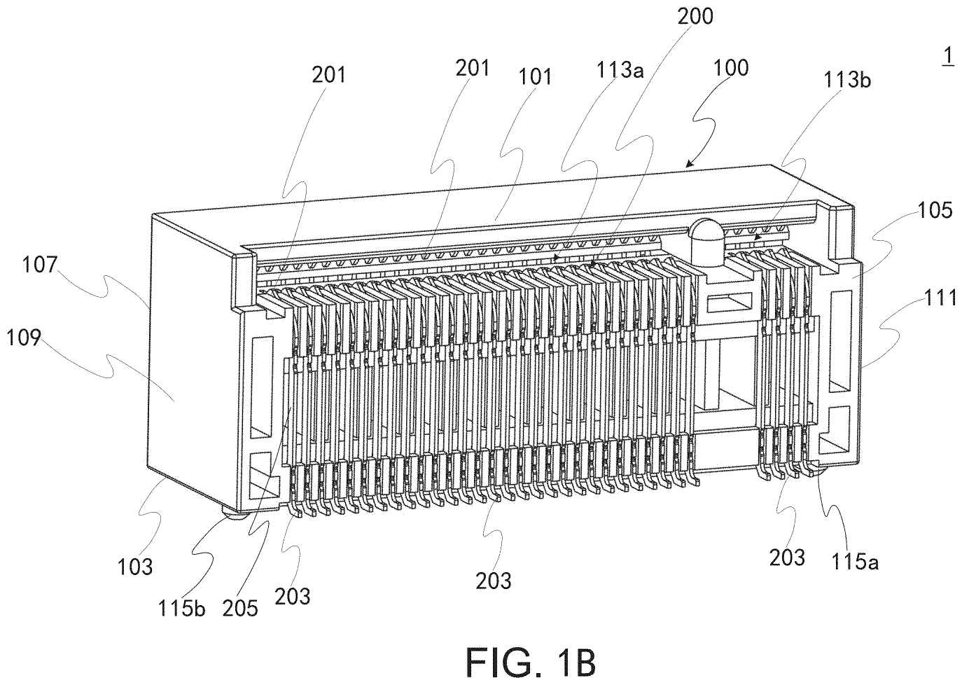

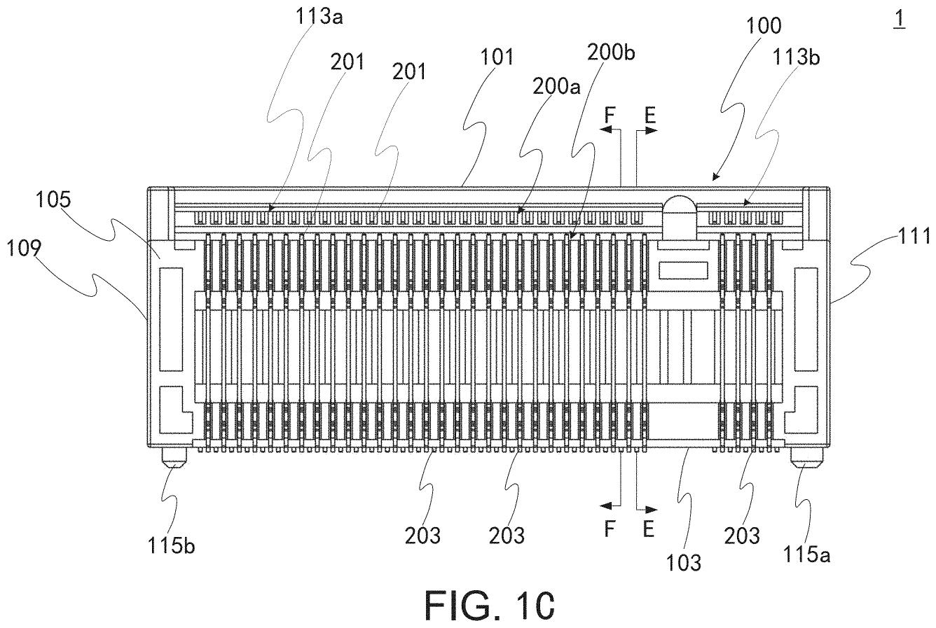

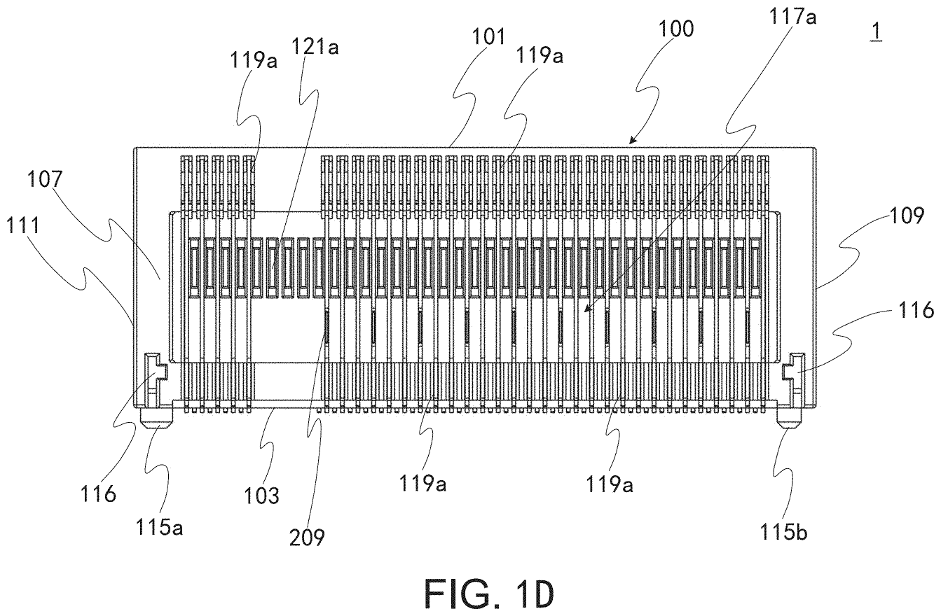

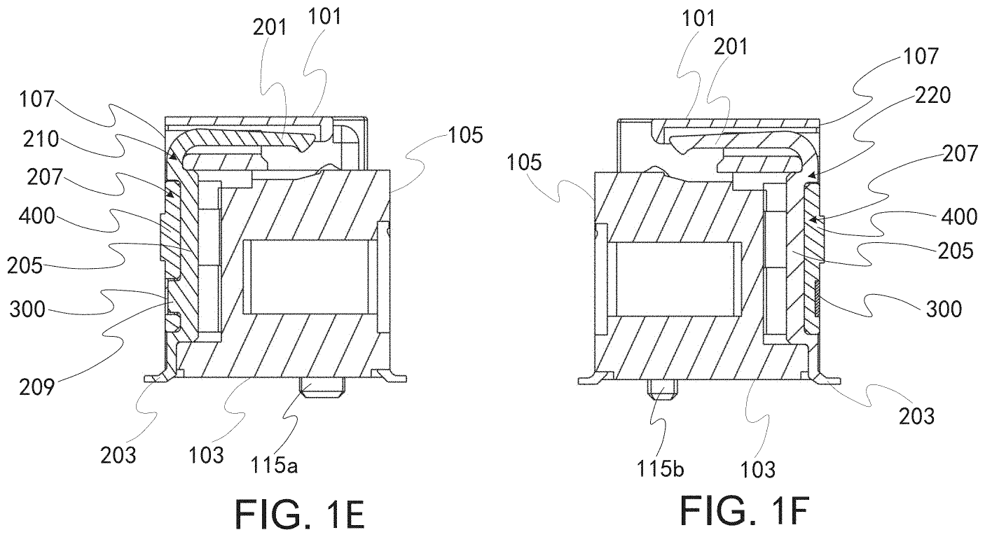

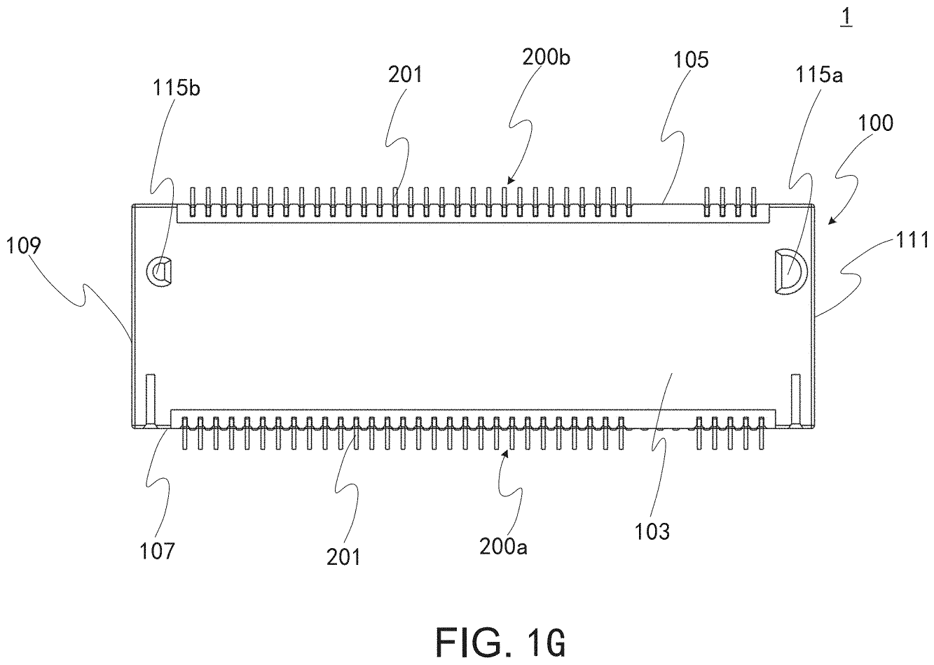

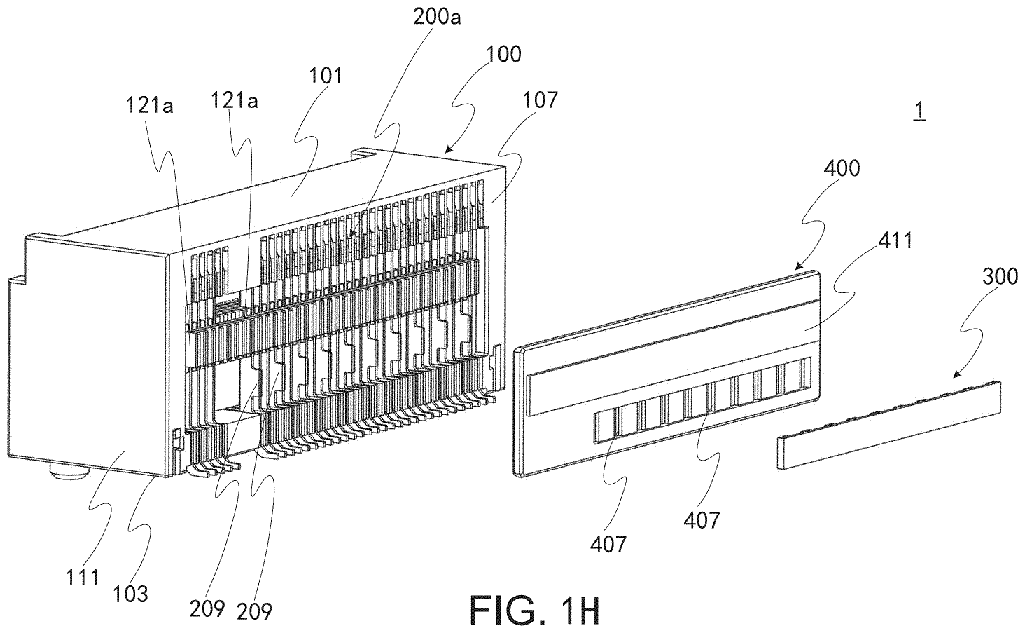

FIGS. 1A to 1H illustrate an electrical connector 1 according to a preferred embodiment of the present disclosure. As shown in FIGS. 1A to 1F, the electrical connector 1 is a right angle connector and may include a front housing member 100 and a plurality of terminals 200 arranged in the front housing member 100. The front housing member 100 may have a substantially block-shaped body and may include a top face 101, a bottom face 103 opposite to the top face 101, and four side faces extending between the top face 101 and the bottom face 103, i.e., front side face 105, rear side face 107, left side face 109 and right side face 111. Examples of materials that are suitable for forming the front housing member 100 include, but are not limited to, plastic, nylon, liquid crystal polymer (LCP), polyphenyline sulfide (PPS), high temperature nylon or polyphenylenoxide (PPO) or polypropylene (PP).

The plurality of terminals 200 may be housed in the front housing member 100. Each of the plurality of terminals 200 may be formed of a conductive material. Conductive materials that are suitable for forming the terminals 200 may be a metal, such as copper, or a metal alloy, such as copper alloy. The plurality of terminals 200 may be configured to establish an electrical connection between a first electronic system, such as a motherboard, and a second electronic system, such as a daughter card. Each of the plurality of terminals 200 may include a contact portion 201, a tail portion 203 and a body portion 205 extending between the contact portion 201 and the tail portion 203 (FIGS. 1D to 1F). The terminal 200 may be bent such that the contact portion 201 and the tail portion 203 can extend at a substantially right angle relative to the body portion 205 respectively. The tail portion 203 may be configured to mount (for example, by soldering) onto the first electronic system. The contact portion 201 may be configured to establish an electrical contact with a conductive portion of the second electronic system.

The terminals 200 may be arranged in rows, with the terminals in each terminal row aligned therein, As shown in FIG. 1C, when the terminals 200 are arranged in the front housing member 100, the terminals 200 are arranged in two rows, i.e., a first terminal row 200a and a second terminal row 200b, which are mutually opposed and spaced apart, with the terminals in each terminal row aligned therein. The first terminal row 200a and the second terminal row 200b can be spaced apart in a manner that the terminals 200 are offset (FIG. 1C) from each other or aligned (not shown) with each other along an arrangement direction. The first terminal row 200a and the second terminal row 200b being offset from each other along the arrangement direction may increase a distance between the terminals in the first terminal row 200a and the second terminal row 200b so as to reduce the scattering between high speed signals, thereby improving the electrical performance of the electrical connector 1. The conductive portions of the second electronic system may be inserted between the terminals in the first terminal row 200a and the second terminal row 200b, such that the conductive portions of the second electronic system are disposed in contact with the contact portions 201 of the corresponding terminals 200. It should be appreciated that the terminals 200 of the electrical connector 1 may also be arranged in any other numbers of rows.

With continuing reference to FIGS. 1A to 1G, when the terminals 200 are held in the front housing member 100, the tail portions 203 of the terminals 200 may be arranged to extend out from the bottom face 103 (which may also be referred to as the “mounting face”) of the front housing member 100 so as to mount onto the first electronic system, such as a motherboard. As shown, the tail portions 203 of the terminals 200 in the first terminal row 200a and the second terminal row 200b may be bent in opposite directions so as to be connected to the corresponding conductive portions of the first electronic system. The connection can be achieved by soldering or any other suitable means. The contact portions 201 of the terminals 200 in the first terminal row 200a and the second terminal row 200b are accessible through sockets in the front side face 105 of the front housing member 100. The conductive portions of the second electronic system may be inserted between the terminals in the first terminal row 200a and the second terminal row 200b, such that the conductive portions of the second electronic system are arranged in contact with the contact portions 201 of the corresponding terminals 200. In this way, the conductive portions of the second electronic system may be electrically connected to the corresponding conductive portions of the first electronic system, such as a motherboard, via the terminals 200, thereby establishing an electrical connection between the second electronic system and the first electronic system. The first electronic system and the second electronic system may communicate with each other through the electrical connector 1 using a standardized protocol, such as a PCI protocol.

One of the four side faces of the front housing member 100 may have at least one socket, such that the contact portion 201 of each of the plurality of terminals 200 is accessible through the socket. Such a side face may also be referred to as the “interfacing face”. The second electronic system, such as a daughter card, may be interfaced with the front housing member 100 via the interfacing face. For example, the conductive portions of the second electronic system may be inserted between the terminals in the first terminal row 200a and the second terminal row 200b through the socket in the interfacing face, such that the conductive portions of the second electronic system are arranged in contact with the contact portion 201 of the corresponding terminals 200. As shown in FIGS. 1B and 1C, the front side face 105 of the front housing member 100 may have two sockets, i.e., a first socket 113a and a second socket 113b, with the contact portions 201 of the respective terminals in the first terminal row 200a and the second terminal row 200b, which are mutually opposed and spaced apart, positioned in the first socket 113a and the second socket 113b, such that the contact portions 201 of the plurality of terminals 200 are accessible through the first socket 113a and the second socket 113b. It should be appreciated that the front side face 105 of the front housing member 100 may have any other numbers of sockets, such as one socket or more than two sockets.

The electrical connector 1 may further include a positioning mechanism provided on the front housing member 100 for ensuring the proper positioning of the electrical connector 1 on the first electronic system, such as a motherboard, when the electrical connector 1 is mounted onto the first electronic system, and for preventing the front housing member 100 from moving along a surface of the first electronic system. For example, the first positioning mechanism may be in the form of a positioning protrusion, two positioning protrusions are shown in FIGS. 1A to 1G: a first positioning protrusion 115a and a second positioning protrusion 115b. The first positioning protrusion 115a and the second positioning protrusion 115b may be provided on the bottom face 103 of the front housing member 100, near the opposite ends of the front housing member 100, respectively. However, it should be appreciated that the first positioning protrusion 115a and the second positioning protrusion 115b may also be provided at any other suitable location. The first positioning protrusion 115a and the second positioning protrusion 115b may be designed to provide a dummy-proof design to prevent the electrical connector 1 from being intentionally or unintentionally mounted in a wrong orientation on the first electronic system. As the electrical connector 1 is mounted onto the first electronic system, the first positioning protrusion 115a and the second positioning protrusion 115b may cooperate with a mating positioning mechanism (for example, a recess or hole) on the first electronic system to ensure that the electrical connector 1 is properly positioned on the first electronic system and to prevent movement of the front housing member 100 along the surface of the first electronic system. It should be appreciated that the positioning mechanism may also be in any other suitable form.

The electrical connector 1 may further include a fixing mechanism for fixing the electrical connector 1 onto the first electronic system, such as a motherboard. For example, the fixing mechanism may be in the form of a mounting slot for receiving a fixing member. In FIG. 1A are shown two mounting slots 116, which may be used to receive fixing members, such as mounting tabs. The fixing members may for example be disposed in the corresponding mounting slots 116 and protrude from the bottom face 103 of the electrical connector 1, with the protruded portions of the fixing members received by mating structures of the first electronic system, whereby the electrical connector 1 can be securely fixed onto the first electronic system. It should be appreciated that the electrical connector 1 may have any other numbers of fixing mechanisms, and/or the fixing mechanisms may be in any other suitable form.

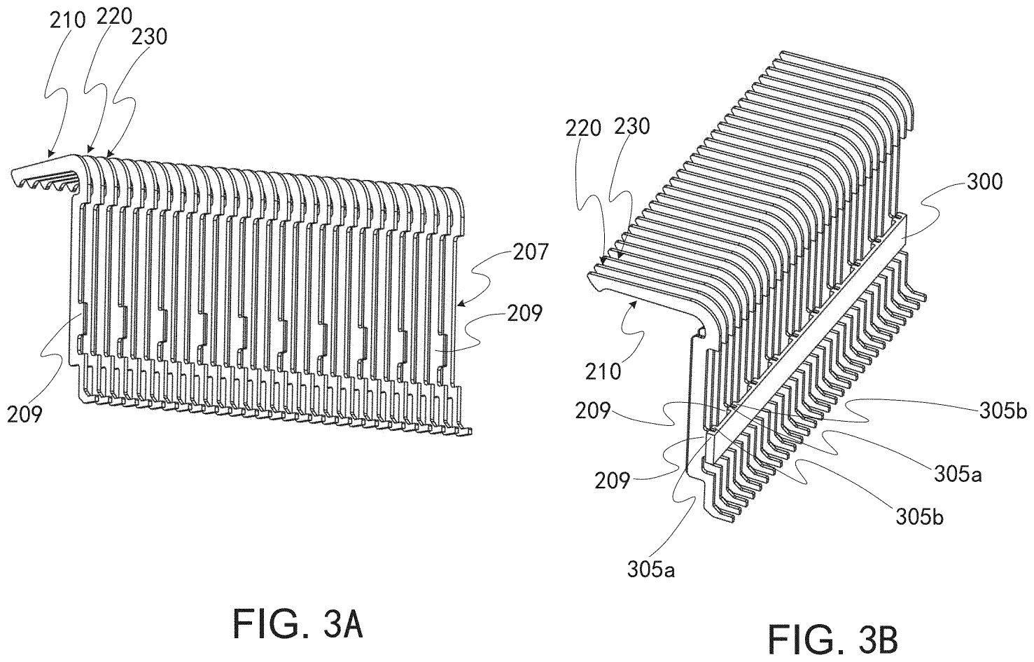

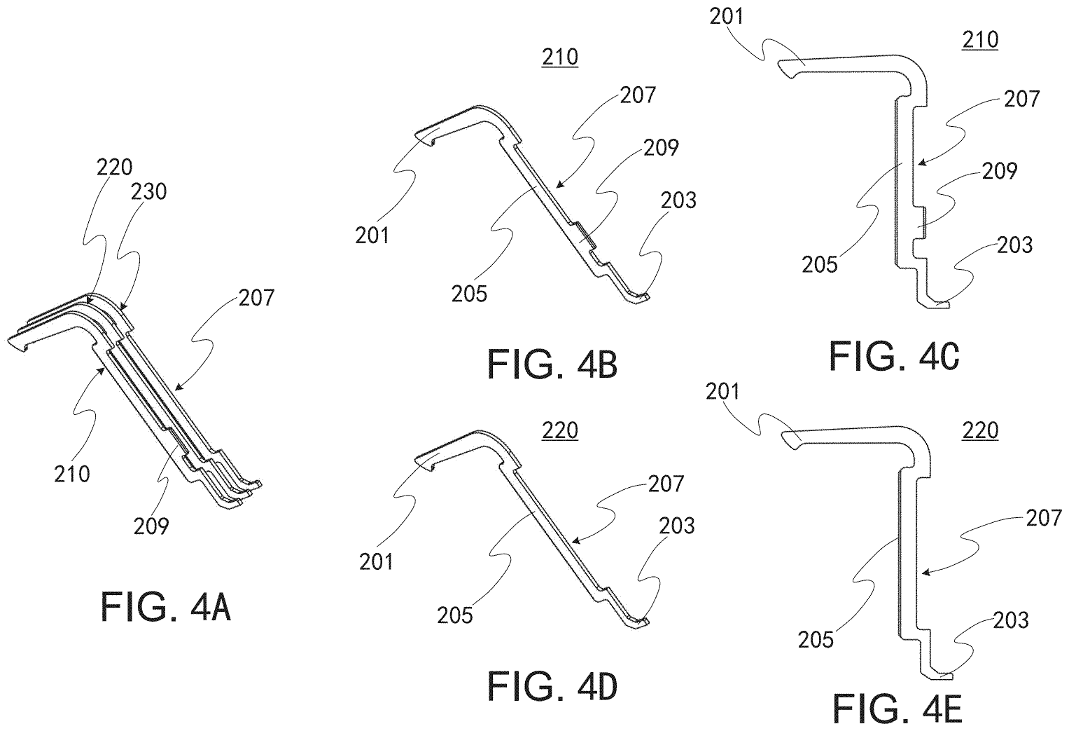

At least some of the terminals 200 of the electrical connector I may be configured for transmitting differential signals. FIGS. 3A and 3B illustrate some of the terminals in the first terminal row 200a, which may include a plurality of terminal sets. FIG. 4A illustrates the leftmost set of three terminals in FIG. 3A in detail. As shown in FIG. 4A, each terminal set may include three terminals, i.e., a ground terminal (“G”) 210, a first signal terminal (“S”) 220 and a second signal terminal (“S”) 230. The first signal terminal 220 and the second signal terminal 230 may have the same configurations. The first signal terminal 220 and the second signal terminal 230 may constitute a differential signaling pair. For example, the first signal terminal 220 may be energized by a first voltage, and the second signal terminal 230 may be energized by a second voltage complementary to the first voltage. The voltage difference between the first signal terminal 220 and the second signal terminal 230 represents a signal. The first terminal row 200a may include a plurality of pairs of signal terminals for transmitting signals. A ground terminal 210 may be arranged adjacent to each pair of the signal terminals to control the impedance of these terminals and to reduce crosstalk among. signals, thereby improving signal integrity. These terminals are aligned in terminal rows in a “G-S-S-G-S-S . . . G-S-S” pattern as shown in FIGS. 3A and 3B, with each pair of the signal terminals sharing a ground terminal.

When transmitting high speed signals (for example, signals at frequencies up to about 25 GHz or up to about 40 GHz, up to about 56 GHz or up to about 60 GHz or up to about 75 GHz or up to about 112 GHz or higher), undesired resonances may occur within the ground terminals 210, which in turn may affect signal integrity. Therefore, it is expected to reduce the effect of resonances through changing the frequency of resonances or attenuating the energy associated with resonances.

In order to reduce the effect of resonances on the electrical performance of electrical connector 1, a bridging member 300 may be incorporated among the ground terminals 210 of the electrical connector 1 to reduce resonances. In particular, the bridging member 300 may provide a conductive or partially conductive path among the ground terminals 210 to control or damp undesired resonances that occur within the ground terminals 210 during operation of the electrical connector 1, thereby improving signal integrity. The ground terminals 210 may be connected to the bridging member 300. The signal terminals (i.e., the first signal terminals 220 and the second signal terminals 230) may be electrically isolated from the bridging member 300. In some examples, the bridging member 300 may change the frequency at which resonance occurs, such that the resonance frequency is outside an intended operating range for a differential signal transmitted via the signal terminals, thereby reducing the effect of resonances on signal integrity, in some examples, the bridging member 300 may dissipate resonant energy to reduce the effect of resonances on signal integrity.

The bridging member 300 may be formed of any suitable material. In some examples, the bridging member 300 may be formed from the same material as that used to form the ground terminal 210 or any other suitable conductive material. In some examples, the bridging member 300 may be formed from an electrically lossy material. For example, the bridging member 300 may be molded of or contain an electrically lossy material.

Materials that conduct, but with some loss, or material which by another physical mechanism absorbs electromagnetic energy over the frequency range of interest are referred. to herein generally as “electrically lossy materials”. Electrically lossy materials can be formed from lossy dielectric and/or poorly conductive and/or lossy magnetic materials. Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Practical lossy magnetic materials or mixtures containing lossy magnetic materials may also exhibit useful amounts of dielectric loss or conductive loss effects over portions of the frequency range of interest. Electrically lossy material can be formed from material traditionally regarded as dielectric materials, such as those that have an electric loss tangent greater than approximately 0.05 in the frequency range of interest. The “electric loss tangent” is the ratio of the imaginary part to the real part of the complex electrical permittivity of the material. Electrically lossy materials can also be formed from materials that are generally thought of as conductors, but are either relatively poor conductors over the frequency range of interest, contain conductive particles or regions that are sufficiently dispersed that they do not provide high conductivity or otherwise are prepared with properties that lead to a relatively weak bulk conductivity compared to a good conductor, such as copper, over the frequency range of interest.

Electrically lossy materials typically have a bulk conductivity of about 1 Siemen/meter to about 10,000 Siemens/meter and in some embodiments about 1 Siemen/meter to about 5,000 Siemens/meter. In some examples, a material with a bulk conductivity of between about 10 Siemens/meter and about 200 Siemens/meter may be used. As a specific example, a material with a conductivity of about 50 Siemens/meter may be used. However, it should be appreciated that the conductivity of the material may be selected empirically or through an electrical simulation using known simulation tools to determine a suitable conductivity that provides a suitably low crosstalk with a suitably low signal path attenuation or insertion loss.

Electrically lossy materials may be partially conductive materials, such as those that have a surface resistivity between 1Ω/square and 100,000Ω/square. In some examples, the electrically lossy material has a surface resistivity between 10Ω/square and 1000Ω/square. As a specific example, the material may have a surface resistivity of between about 20Ω/square and 80Ω/square.

In some examples, electrically lossy material is formed by adding to a binder a filler that contains conductive particles. In such examples, the bridging member 300 may be formed by molding or otherwise shaping the binder with filler into a desired form. Examples of conductive particles that may be used as a filler to form an electrically lossy material include carbon or graphite formed as fibers, flakes, nanoparticles, or other types of particles. Metal in the form of powder, flakes, fibers or other particles may also be used to provide suitable electrically lossy properties. Alternatively, combinations of fillers may be used. For example, metal plated carbon particles may be used. Silver and nickel are suitable metal plating materials for fibers. Coated particles may be used alone or in combination with other fillers, such as carbon flake. The binder or matrix may be any material that will set, cure, or can otherwise be used to position the filler material. In some examples, the binder may be a thermoplastic material traditionally used in the manufacture of electrical connectors to facilitate the molding of the electrically lossy material into the desired shapes and locations as part of the manufacture of the electrical connectors. Examples of such materials include liquid crystal polymer (LCP) and nylon. However, many alternative forms of binder materials may be used. Curable materials, such as epoxies, may serve as a binder. Alternatively, materials, such as thermosetting resins or adhesives, may be used.

Also, while the above-described binder materials may be used to create an electrically lossy material by forming a binder around conducting particle fillers, the disclosure is not so limited. For example, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

In some embodiments, the fillers will be present in a sufficient volume percentage to allow conducting paths to be created from particle to particle. For example, when a metal fiber is used, the fiber may be present in about 3% to 40% by volume. The amount of filler may impact the conducting properties of the material.

Filled materials may be purchased commercially, such as materials sold under the trade name Celestran® by Celanese Corporation which can be filled with carbon fibers or stainless steel filaments. A lossy material, such as lossy conductive carbon filled adhesive preform, such as those sold by Techfilm of Billerica, Mass., US, may also be used. This preform can include an epoxy binder filled with carbon fibers and/or other carbon particles. The binder surrounds carbon particles, which act as a reinforcement for the preform. Such a preform may be inserted in a connector wafer to form all or part of the housing. In some examples, the preform may adhere through the adhesive in the preform, which may be cured in a heat treating process. In some examples, the adhesive may take the form of a separate conductive or non-conductive adhesive layer. In some examples, the adhesive in the preform alternatively or additionally may be used to secure one or more conductive elements, such as foil bars, to the lossy material.

Various forms of reinforcing fiber, in woven or non-woven form, coated or non-coated may be used. Non-woven carbon fiber is one suitable material. Other suitable materials, such as custom blends as sold by RIP Company, can be employed, as the present disclosure is not limited in this respect.

In some examples, the bridging member 300 may be manufactured by stamping a preform or sheet of the lossy material. For example, the bridging member 300 may be formed by stamping a preform as described above with a die having an appropriate pattern. However, other materials may be used instead of or in addition to such a preform. A sheet of ferromagnetic material, for example, may be used.

However, the bridging member 300 may also be formed in other ways. In some examples, the bridging member 300 may be formed by interleaving layers of lossy and conductive material, such as a metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, the bridging member 300 may be formed by plating plastic or other insulative material with a lossy coating, such as a diffuse metal coating.

As shown in FIGS. 1A, 1E, 1F and 1H, the electrical connector 1 may further include a cover member 400 which can be mounted to the front housing member 100 in any suitable way. The bridging member 300 may be disposed in the cover member 400 and connect the ground terminals 210 together. In other words, the cover member 400 may be mounted to the front housing member 100 such that the ground terminals 210 of the plurality of terminals 200 are connected to the bridging member 300. In this way, the bridging member 300 may provide a conductive or partially conductive path among the ground terminals 210 to control or damp undesired resonances occurring within the ground terminal 210 during operation of the electrical connector 1, thereby improving signal integrity.

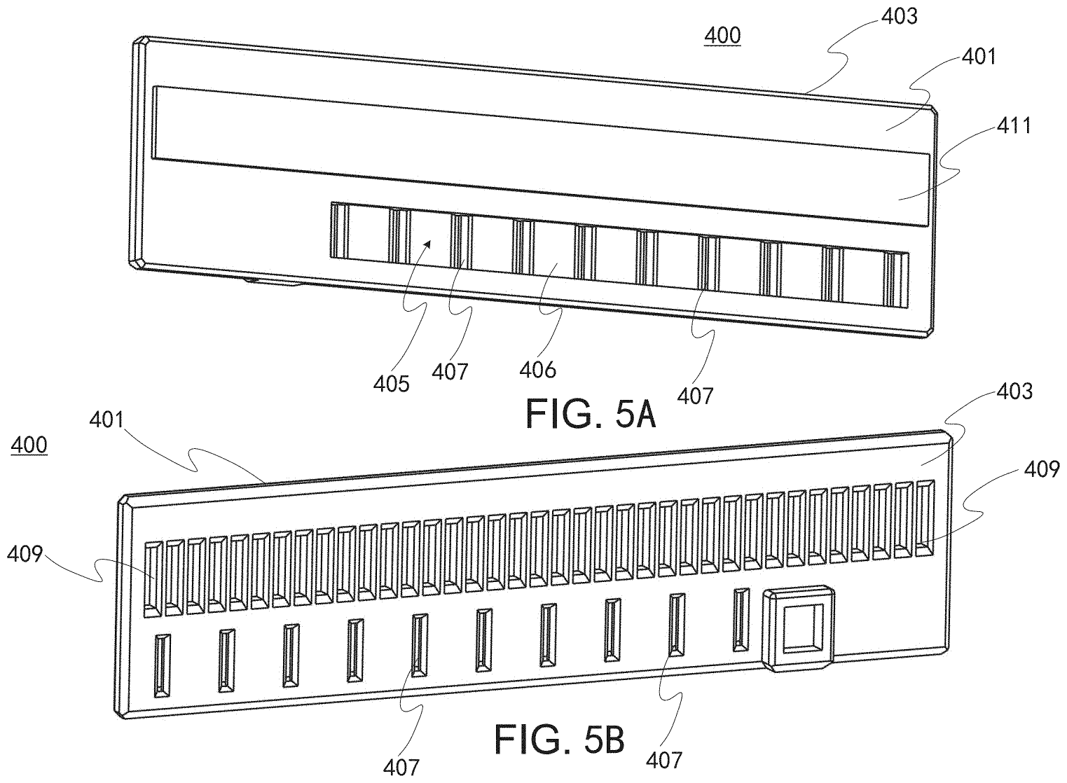

With continued reference to FIGS. 5A and 5B, the cover member 400 may have a plate-like shape and may include a first surface (which may also be referred to as “outer surface”) 401 and a second surface (which may also be referred to as “inner surface”) 403 opposite to the first surface 401. The first surface 401 faces outward when the cover member 400 is mounted to the front housing member 100, and the second surface 403 faces inward when the cover member 400 is mounted to the front housing member 100, and faces the first terminal row 200a, as shown in FIGS. 1A, 1E, 1F and 1H. A first recess 405 is recessed from the first surface 401 into the cover member 400 for receiving the bridging member 300. A first set of slots 407 extends from the second surface 403 opposite to the first surface 401 through the cover member 400 to the bottom face 406 of the first recess 405 such that at least a portion of the bridging member 300 is accessible via the first set of slots 407 when the bridging member 300 is disposed in the first recess 405. The cover member 400 may be made of any suitable material. In some embodiments, the cover member 400 may be made of an insulative material. Examples of insulative materials that are suitable for forming the cover member 400 include, but are not limited to, plastic, nylon, liquid crystal polymer (LCP), polyphenyline sulfide (PPS), high temperature nylon or polyphenylenoxide (PPO) or polypropylene (PP).

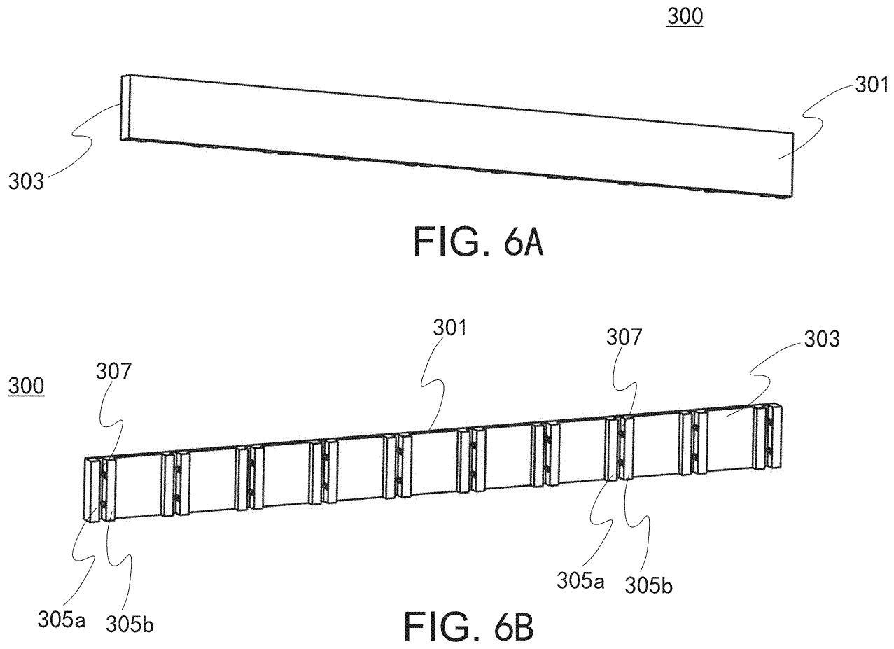

The bridging member 300 may be arranged on the cover member 400 in any suitable way. As shown in FIGS. 6A and 6B, the bridging member 300 may be bar-shaped and include a first surface 301 and a second surface 303 opposite to the first surface 301. The first surface 301 faces outward and may be substantially flush with the first surface 401 of the cover member 400 when the bridging member 300 is disposed in the first recess 405 in the cover member 400. The second surface 303 faces inward when the bridging member 300 is disposed in the first recess 405 in the cover member 400. The bridging member 300 may also include a plurality of pairs of ribs 305a and 305b extending from the second surface 303. Each pair of ribs 305a and 305b defines a slot 307 therebetween fir receiving a mating portion (which will be described in detail below) of a corresponding ground terminal 210. When the bridging member 300 is disposed in the first recess 405 in the cover member 400, each pair of the plurality of pair of ribs 305a and 305b may extend into and be accessible via a corresponding slot 407 of the first set of slots 407 in the cover member 400. The mating portion of the ground terminal 210 can be inserted into the slot 307 through the slot 407. In this way, the mating portion of the ground terminal 210 can be sandwiched between a pair of ribs 305a and 305b, thereby allowing the ground terminal 210 to be connected to the bridging member 300.

In some examples, the bridging member 300 may be configured as a separate member to be installed (for example, inserted) into the first recess 405 in the cover member 400 before or after the cover member 400 is mounted to the front housing member 100. In some other examples, the bridging member 300 may be molded into the first recess 405 in the cover member 400 before or after the cover member 400 is mounted to the front housing member 100.

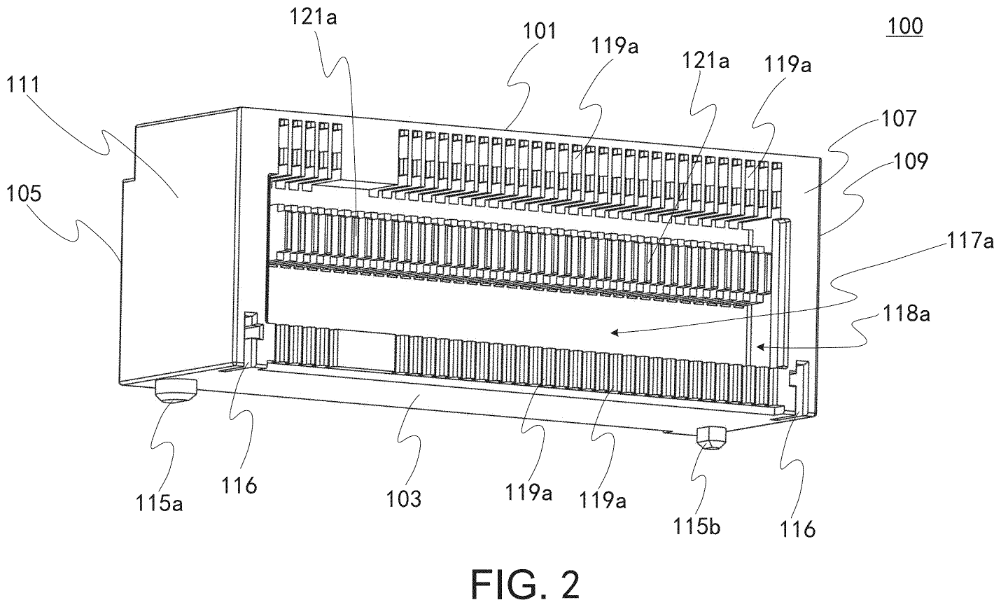

Turning back to FIG. 2, FIG. 2 illustrates the front housing member 100 of the electrical connector 1 in detail. The front housing member 100 may include a first cavity 117a for arranging the first terminal row 200a. The rear side face 107 of the front housing member 100 may include a first opening 118a configured for opening to the first cavity 117a. The front housing member 100 may also include a plurality of terminal slots 119a extending from the first cavity 117a for receiving the terminals in the first terminal row 200a. The plurality of terminal slots 119a may open to the sockets 113a and 113b, respectively, such that the contact portion 201 of each terminal of the first terminal row 200a can extend into and be accessible via the sockets. The number of terminal slots 119a may correspond to the number of terminals in the first terminal row 200a, such that each terminal in the first terminal row 200a can be disposed in a corresponding terminal slot 119a.

With continued reference to FIGS. 1A, 1E, and 1F, when the cover member 400 is fixed to the front housing member 100, the cover member 400 may retain each terminal in the first terminal row 200a in place in the first cavity 117a. As shown in FIGS. 3A and FIGS. 4A to 4E, the body portion 205 of each terminal (including the ground terminal 210, the first signal terminal 220 and the second signal terminal 230) in the first terminal row 200a may be configured to form an accommodation space 207. That is, when the terminals are arranged in the first terminal row 200a, each terminal in the first terminal row 200a is aligned in the terminal row and the accommodation space 207 formed by the body portion 205 of each terminal are aligned. Turning to FIGS. 1E and 1F, a dimension of the accommodation space 207 may match with a cross-sectional dimension (perpendicular to the first surface 401 or the second surface 403) of the cover member 400 such that the cover member 400 can be received in the accommodation space 207. That is, the cover member 400 may be received in the accommodation space 207 when the cover member 400 is disposed in the first cavity 17a. In this way, the cover member 400 can press tightly against each terminal in the first terminal row 200a, thereby retaining each terminal in the first terminal row 200a in place in the first cavity 117a. This eliminates the need to retain each terminal in the first terminal row 200a in place by overmolding the front housing member 100 around the first terminal row 200a or by providing an additional terminal retention mechanism, thereby simplifying the manufacture and assembly of the electrical connector and reducing the cost thereof. In addition, when the cover member 400 is disposed into the first cavity 117a, the first surface 401 of the cover member 400 may be substantially flush with the rear side face 107 of the front housing member 100. This allows the cover member 400 to be mounted in the front housing member 100 without substantially changing the external dimensions of the front housing member 100 and thus without increasing the space occupied by the electrical connector on the electronic system.

In order to connect the ground terminals 210 to the bridging member 300, as shown in FIGS. 3A to 3B and FIGS. 4A to 4C, the ground terminal 210 may also include a protruding portion 209 extending from the body portion 205 into the accommodation space 207, and the protruding portion 209 may be used as the aforementioned mating portion of the ground terminal 210. As shown in FIG. 1E, when the bridging member 300 is disposed in the cover member 400 and the cover member 400 is received in the accommodation space 207, each slot 407 of the first set of slots 407 in the cover member 400 is aligned with a corresponding ground terminal 210 such that the protruding portions 209 of the ground terminals 210 can be inserted into the slots 307 of the bridging member 300 through the slots 407 in the cover member 400. In this way, the protruding portion 209 of the ground terminal 210 may be sandwiched between ribs 305a and 305b such that the ground terminal 210 is connected to the bridging member 300. FIG. 3B further illustrates the ground terminal 210 in the first terminal row 200a connected to the bridging member 300, with the cover member removed for ease of illustration.

As shown in FIGS. 3A, 3B, 4A, 4D, and 4E, the first signal terminal 220 is devoid of a protruding portion similar to the protruding portion 209 of the ground terminal 210. As the second signal terminal 230 has the same configuration as that of the first signal terminal 220, the second signal terminal 230 is also devoid of a protruding portion similar to the protruding portion 209 of the ground terminal 210. As shown in FIG. 1F, when the bridging member 300 is disposed in the cover member 400 and the cover member 400 is received in the accommodation space 207, the cover member 400 may space the first signal terminal 220 and the second signal terminal 230 apart from the bridge member 300, thereby electrically isolating the bridge member 300 from the first signal terminal 220 and the second signal terminal 230.

The cover member 400 may be secured to the front housing member 100 in any suitable way. In some examples, the cover member 400 may be secured to the front housing member 100 by a hot melt process. In particular, as shown in FIG. 2, the front housing member 100 may include a first set of protrusions 121a extending into the first cavity 117a. As shown in FIG. 5B, the cover member 400 may include a second set of slots 409 for receiving the first set of protrusions 121a of the front housing member 100. When the cover member 400 is received in the accommodation space 207, each of the first set of protrusions 121a of the front housing member 100 may be inserted into a corresponding slot of the second set of slots 409. The hot melt bar 411 is then applied to the cover member 400, and heated and melted to flow into the second set of slots 409 so as to secure the first set of protrusions 121a in the slots 409, thereby securing the cover member 400 to the front housing member 100. It should be appreciated that the hot melt bar 411 may be formed integrally with the cover member 400, or may be formed separately from the cover member 400 and then applied to the cover member 400. It should also be appreciated that the cover member 400 may also be secured to the front housing member 100 in other suitable manner, such as by a snap fit connection or a bolt connection.

As compared with conventional electrical connectors, the electrical connector 1 according to the preferred embodiments of the present disclosure provides at least one of the following advantages: (1) attaching the bridging member 300 to the electrical connector 1 by using the cover member 400 can simplify the manufacture and assembly of the electrical connector and reduce the cost thereof; (2) through receiving the cover member 400 in the accommodation space formed by the body portion of the terminals, it is possible to mount the cover member 400 in the front housing member 100 without substantially changing the external dimensions of the front housing member 100 and thus without increasing the space occupied by the electrical connector on the electronic system; (3) through retaining the terminals in place by the cover member 400, it is possible to eliminate the needs to overmold the front housing member 100 around the terminals or the needs to provide an additional terminal retention mechanism, thereby simplifying the manufacture and assembly of the electrical connector and reducing the cost thereof; (4) connecting the ground terminals 210 to the bridge member 300 by inserting the protruding portions 209 of the ground terminals 210 between the ribs 305a and 305b of the bridge member 300 through the slots 407 in the cover member 400, it is possible to simplify the assembly of the electrical connector and reduce the cost thereof; (5) through securing the cover member 400 to the front housing member 100 by a hot-melt process, it is possible to improve the stability of attachment of the bridging member 300 to the electrical connector 1.

Although the present disclosure is described in detail with respect to only the terminals in the first terminal row 200a, it should be appreciated that the electrical connector 1 may also include an additional bridging member similar to the bridging member 300 and an additional cover member similar to the cover member 400, so as to provide at least one of the above advantages. For example, the additional cover member may be mounted to the front housing member 100, and the additional bridging member may be disposed in the additional cover member and connect the ground terminals in the second terminal row 200b together. It should also be appreciated that the electrical connector 1 may also include only one terminal row, or may include more than two terminal rows. Accordingly, the electrical connector 1 may comprise at least one cover member.

Although the present disclosure is described in detail above in connection with a right angle connector, it should be appreciated that the present disclosure is also applicable to vertical connectors and other suitable types of electrical connectors. Unlike the right angle connector, in a vertical connector, a socket is formed in a top face of the front housing member opposite to a bottom face (in other words, in a vertical connector, an interfacing face is provided opposite to a mounting surface), and terminals of the vertical connector are configured such that contact portions of the terminals are accessible via the socket. The vertical connector may also be used to connect a second electronic system, such as a daughter card, to a first electronic system, such as a mother board. In some examples, the vertical connector may be configured for mounting to the first electronic system, such as a motherboard, such that the tail portions of the terminals of the vertical connector are electrically connected to the conductive portions (for example, conductive traces) of the first electronic system. The second electronic system, such as a daughter card, may be inserted into the socket such that the conductive portions of the second electronic system are disposed in contact with the contact portions of the corresponding terminals. In this way, the conductive portions of the second electronic system may be electrically connected to the corresponding conductive portions of the first electronic system via the terminals of the vertical connector, thereby establishing an electrical connection between the second electronic system and the first electronic system. The first electronic system and the second electronic system may communicate with each other by transmitting signals using the vertical connector using a standardized protocol, such as a PCI protocol.

It should also be appreciated that the terms “first” and “second” are only used to distinguish an element or component from another element or component, and that these elements and/or components should not be limited by the terms.

The present disclosure has been described in detail in conjunction with specific embodiments. Obviously, the above description and the embodiments shown in the appended drawings should be understood to be exemplary and do not constitute a limitation on the present disclosure. For a person skilled in the art, various variations or modifications can be made without departing from the spirit of the present disclosure, and these variations or modifications fall within the scope of the present disclosure.

What is claimed is:

1. An electrical connector, comprising:
a front housing member comprising a front member and a cover member mounted to a rear of the front member;
a plurality of terminals arranged in the front housing member; and
a bridging member comprising portions extending through the cover member and engaging a subset of the plurality of terminals.

2. The electrical connector of claim 1, wherein the bridging member provides a conductive or partially conductive path among ground terminals of the plurality of terminals.

3. The electrical connector of claim 1, wherein the bridging member is made of an electrically lossy material.

4. The electrical connector of claim 1, wherein the plurality of terminals are arranged in two terminal rows mutually opposed and spaced apart, with the terminals in each of the terminal row aligned therein.

5. The electrical connector of claim 4, wherein the two terminal rows are spaced apart in a manner that the terminals are offset from each other or aligned with each other along an arrangement direction.

6. The electrical connector of claim 1, wherein:
at least a portion of the plurality of terminals each comprises a contact portion, a tail portion, and a body portion extending between the contact portion and the tail portion, and
for each of the at least a portion of the plurality of terminals, an accommodation space forms adjacent the body portion.

7. The electrical connector of claim 6, wherein a dimension of the accommodation space matches with a cross-sectional dimension of the cover member such that the cover member can be received in the accommodation space.

8. The electrical connector of claim 7, wherein the cover member is fused to the front housing member and retains the at least a portion of the plurality of terminals in the front housing member.

9. The electrical connector of claim 1, wherein:
the cover member comprises a recess, and
the bridging member is disposed in the recess such that an outer surface of the cover member is approximately flush with an outer surface of the front member.

10. The electrical connector of claim 6, wherein
the plurality of terminals comprises signal terminals and ground terminals,
the ground terminals form the subset of the plurality of terminals, and
the ground terminals comprise protruding portions extending from the body portions of the ground terminals into respective accommodation spaces.

11. An electrical connector, comprising:
a front housing member;
a plurality of terminals disposed in a row in the front housing member, the plurality of terminals each comprising a contact portion, a tail portion, a body portion extending between the contact portion and the tail portion, and an accommodation space in parallel to the body portion, the plurality of terminals comprising ground terminals comprising protrusion portions protruding into respective accommodation spaces; and
a lossy member comprising slots receiving the protrusion portions of the ground terminals.

17. The electrical connector of claim 11, wherein:
the front housing member comprises top and bottom faces opposite each other, left and right side faces opposite each other, and front and rear side faces opposite each other, the front side face comprising a socket, the rear side face comprising a cavity, and
the electrical connector comprises a cover member disposed in the cavity of the rear side face of the front housing member and fused to the front housing member.

13. The electrical connector of claim 12, wherein:
the cover member comprises slots, and
the slots of the lossy member are accessible via the slots of the cover member.

14. The electrical connector of claim 13, wherein the protruding portions of the ground terminals protrude into the slots of the cover member.

15. The electrical connector of claim 11, wherein:
the lossy member comprises a plurality of pairs of ribs, and
the slots of the lossy member are between pairs of the plurality of pairs of ribs.

16. The electrical connector of claim 15, wherein:
the protruding portions of the ground terminals are sandwiched between respective pairs of the plurality of pairs of ribs whereby the ground terminals are connected to the lossy member.

17. The electrical connector of claim 12, wherein the cover member comprises a recess for receiving the lossy member.

18. A method of manufacturing an electrical connector comprising a plurality of terminals each comprising a contact portion, a tail portion, and a body portion extending between the contact portion and the tail portion, the method comprising:
inserting the plurality of terminals into a front housing member through an opening in a rear of the front housing;
inserting a cover member into the opening in the rear and securing the cover member to the front housing; and
filling a cavity of the cover member with lossy material.

19. The method of claim 18, wherein the cover member is secured to the front housing member by a hot melt process.

20. The method of claim 18, wherein the filling the cavity of the cover member with the lossy material comprises
before or after the cover member is attached, molding the lossy material into the cavity, or inserting a member molded from the lossy material into the cavity.
